(19) United States
(12) Patent Application Publication
(10) Pub. No.: US 2007/0222258 A1
(43) Pub. Date: Sep. 27, 2007

(54) ESCAPE HATCH

(76) Inventors: Paul Bacco, Phoenix, AZ (US); David Bosch, Phoenix, AZ (US); Dean Leo Jacobson, Tempe, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/626,697

(22) Filed: Jan. 24, 2007

Related U.S. Application Data
(60) Provisional application No. 60/743,182, filed on Jan. 27, 2006.

(51) Int. Cl. B62D 33/04

(52) U.S. Cl. 296/182.1

(57) ABSTRACT

An escape hatch for use with an enclosure such as a tractor trailer is disclosed. The escape hatch comprises an opening defined by the body of the enclosure and a door that is secured to opening by an opening mechanism and a latch mechanism. The escape hatch prevents people from becoming trapped in an enclosure and provides a safe route of escape should a person inadvertently be locked in the enclosure.

### CROSS REFERENCE TO RELATED APPLICATION

This Application claims priority to and the benefit of U.S. Provisional Patent Application No. 60/743,182 which was filed on Jan. 27, 2006 and entitled “Trailer Escape/Container Escape Hatch System” wherein such application is incorporated in its entirety by reference.

### FIELD OF INVENTION

This invention relates, generally, to devices and systems for providing egress from externally locked enclosures such as a dry van trailer, a box van, a cargo container, a reefer, a semi-trailer, a large storage locker, a garage, a tractor trailer, and the like. The invention also relates to methods of modifying enclosures to include the present invention.

### BACKGROUND OF THE INVENTION

Trailers for transporting and storing goods are generally known. Such trailers typically have at least one door that provides access to the interior of the trailer and facilitates loading and unloading of goods within. Trailer doors are usually secured via an external locking mechanism. External locking mechanisms, such as locking rods, padlocks, crossbars, and the like, are known in the art.

Such external locking mechanisms generally prevent the doors from opening unintentionally. However, one disadvantage of such external locking mechanisms is that they cannot be activated by a person inside the trailer, thereby trapping the person inside. In this regard, hundreds of people every year become trapped inside trailers in the United States alone.

Moreover, this problem may be more prevalent in the case of trailers used to transport goods long-distance, such as semi-trailers. For example, due to their size, it may take several people working simultaneously to load the trailer, thereby increasing the likelihood that a worker may become trapped inside when the semi-trailer is sealed with an external locking mechanism. Not only may workers become trapped inside, but stowaways and children may also become trapped. More nefariously, trailers with external locking mechanisms may be used to trap and smuggle humans throughout the United States. Entrapment in a semi-trailer that is being transported cross-country may be especially dangerous because the semi-trailer may not be opened during transit. A long period of transit may increase the possibility that a person trapped inside will not survive.

Another disadvantage of existing trailers is that the doors are typically located at one or both ends of the trailer. Although such door location facilitates loading and unloading of cargo, fresh air and light in certain areas of the trailer, such as the center, may be restricted thereby potentially creating dark and dangerous conditions for workers.

Accordingly, there is a need for an invention that, among other benefits, (1) provides a route of quick egress from a trailer if a human becomes trapped inside; (2) does not permit unauthorized external access to the locked trailer; (3) provides an additional optional source of light and air while loading and unloading the trailer; and (4) may be inexpensively installed on existing trailers.

### SUMMARY OF THE INVENTION

While the way that the present invention overcomes the disadvantages of the known art will be discussed in greater detail below, in general, the present invention simultaneously provides a route of egress from a trailer while preventing unauthorized exterior access. The present invention may also provide an additional source of light and fresh air to the interior of the trailer and may be inexpensively installed on an existing trailer. Preliminarily, the present invention is described herein largely in connection with enclosures such as trailers, particularly, semi-trailers. However, one skilled in the art will appreciate that in the context of the present invention, numerous containers/units, such as a dry van trailer, a box van, a cargo container, a reefer, a semi-trailer, a large storage locker, a garage, a tractor trailer, or anything capable of enclosing and/or trapping a person inside may fall within the scope of the present invention.

In accordance with an exemplary embodiment of the present invention, an escape hatch for use with an enclosure is provided. In various embodiments, an escape hatch may comprise a door connected to a peripheral frame via an attachment mechanism, an opening mechanism secured to the interior side of the door, and a latch mechanism secured to the edge of the door. Additionally, in various embodiments, the invention may further comprise weather stripping to form a hermetic seal around the peripheral frame, stairs to facilitate easy egress, and an alarm to signal that the escape hatch is ajar.

In one exemplary embodiment of the present invention, an enclosure is built with an escape hatch. In another exemplary embodiment, an escape hatch system is installed on an existing enclosure such as a trailer. In this embodiment, a location for the escape hatch is selected and an opening large enough to permit egress is cut from the enclosure. The material cut from the enclosure is then converted to a door by adding a latching mechanism and an opening mechanism, such as a handle. A peripheral frame is then installed around the opening and the door is pivotally secured to the peripheral frame via an attachment mechanism, such as spaced-apart hinges.

### BRIEF DESCRIPTION OF THE DRAWINGS

A more complete understanding of the present invention may be derived by referring to the detailed description in connection with the Figures.

FIG. 1 depicts an external perspective view of an exemplary embodiment of an open escape hatch located on a rear section of a trailer;

FIG. 2 depicts an external perspective view of an exemplary embodiment of a closed escape hatch located on a side section of a trailer;

FIG. 3 depicts an external perspective view of an exemplary embodiment of an open escape hatch located on the side section of a trailer;

FIG. 4 depicts an external perspective view of an exemplary embodiment of an open escape hatch having stairs; and

FIG. 5 depicts an internal perspective view of an exemplary embodiment of a closed escape hatch.

### DETAILED DESCRIPTION OF THE INVENTION

The description that follows is not intended to limit the scope, applicability or configuration of the invention in any way; rather, it is intended to provide a convenient illustration for implementing various embodiments of the present invention. As will become apparent, various changes may be made in the function and arrangement of the elements described in these embodiments without departing from the scope of the invention. It should be appreciated that the description herein may be adapted to be employed having differently shaped openings, doors, attachment mechanisms and opening mechanisms and the like and still fall within the scope of the present invention. Thus, the detailed description herein is presented for the purpose of illustration only and not of limitation.

For the sake of brevity, functional embodiments of the apparatus and systems (and components of the individual operating components of the systems) may not be described in detail herein. Furthermore, any connecting lines shown in the various figures contained herein are intended to represent exemplary functional relationships and/or physical connections between the various elements. It should be noted that many alternative or additional functional relationships or physical connections may be present in a practical system.

An escape hatch in accordance with various embodiments of the present invention is generally any structure that simultaneously provides a route of egress from an enclosure while preventing exterior access. As such, in one exemplary embodiment, the invention may comprise an opening with a peripheral frame on an enclosure, a door, an opening mechanism, and a latching mechanism. The door is secured to the peripheral frame via an attachment mechanism. The opening mechanism is secured to the interior side of the door to permit the door to open from the inside. The latching mechanism is secured to the door and locks onto the peripheral frame when the door is closed to hold the door shut. Optionally, the invention may further comprise an internal locking mechanism, stairs, and/or an alarm. In certain exemplary embodiments, the latching mechanism is electronically controlled by wired or wireless devices and is remotely operable.

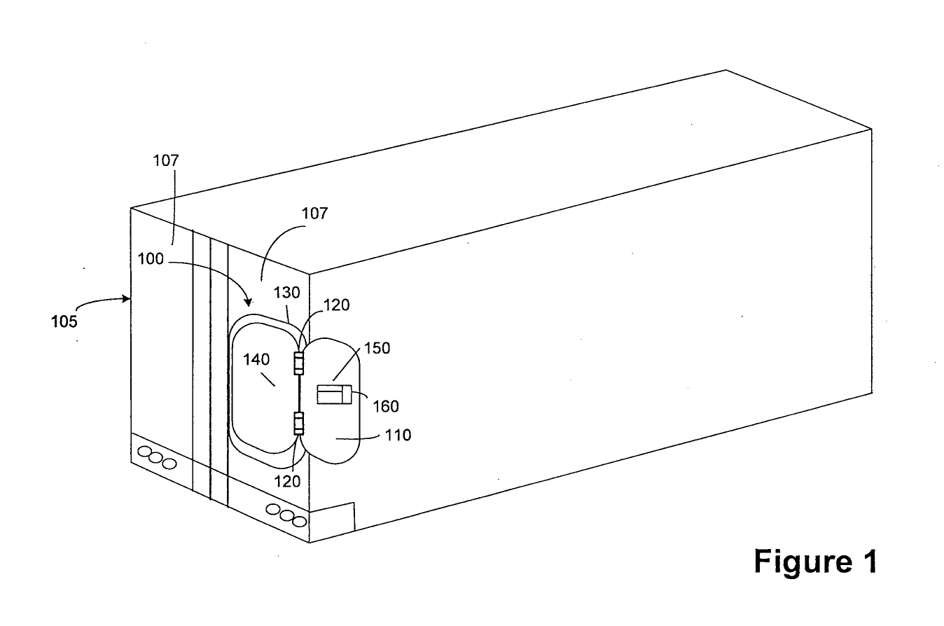

FIG. 1 shows an exemplary embodiment of an escape hatch 100 located on the rear section of an exemplary enclosure such as a trailer 105 comprising a door 110 connected to a peripheral frame 130 of an opening 140 via an attachment mechanism 120. In one exemplary embodiment of the present invention, escape hatch 100 is located on a trailer 105. However, as mentioned above, it will be appreciated by one skilled in the art that the present invention may be located on any enclosure or structure comprising a body with interior and exterior sides that is suitable for storing and/or transporting goods, such as, for example, a dry van trailer, a box van, a cargo container, a reefer, a semi-trailer, a large storage locker, a garage, a tractor trailer, and the like.

In accordance with various applications of the present invention, an exemplary trailer comprises a body with front and rear sections connected together by side sections. Typically, the rear section comprises one or more ingress/egress doors 107 that swing outward to enable the trailer to be loaded and unloaded. Other exemplary trailers comprise a single ingress/egress door that may collapse upon itself (typically by rolling up upon themselves) to open and expand to a flat state when closed. The ingress/egress doors 107 are generally the same dimensions as the front and side section and comprise the entire rear section to enable the trailer to be easily loaded and unloaded. One or more locking mechanisms secure the ingress/egress doors 107 to the body of trailer 105.

The body of trailer 105 can be constructed from any known material such as aluminum. However, those skilled in the art will appreciate that trailer 105 may be constructed of any suitable material such as, for example, steel, plastic, plywood, and the like. Additionally, trailer 105 may be general purpose, or may be used to transport specific goods, such as refrigerated or liquid goods. Furthermore, trailer 105 may be configured as a portable cargo-style container for long distance transport, such as on ships, railroad cars and trucks.

In accordance with various alternative or additional embodiments, multiple escape hatches 100 may be configured in different locations to create alternative routes of egress. For example, one or more escape hatches 100 may be provided in the side, rear or top of trailer 105. Further, escape hatch 100 can be located anywhere along the enclosure or trailer 105 such as the side section or within the rear sections that define ingress/egress door 107.

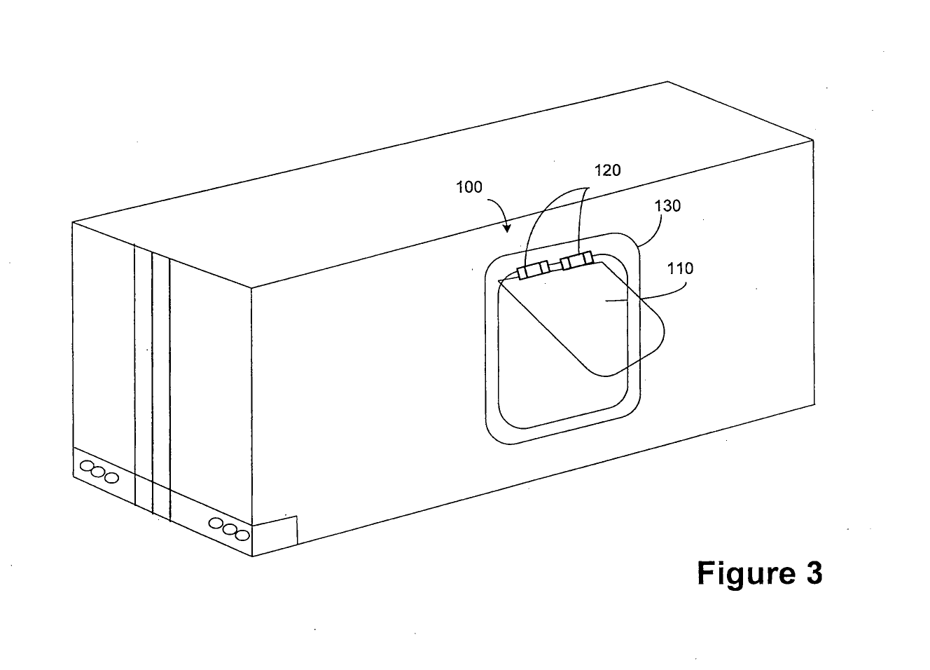

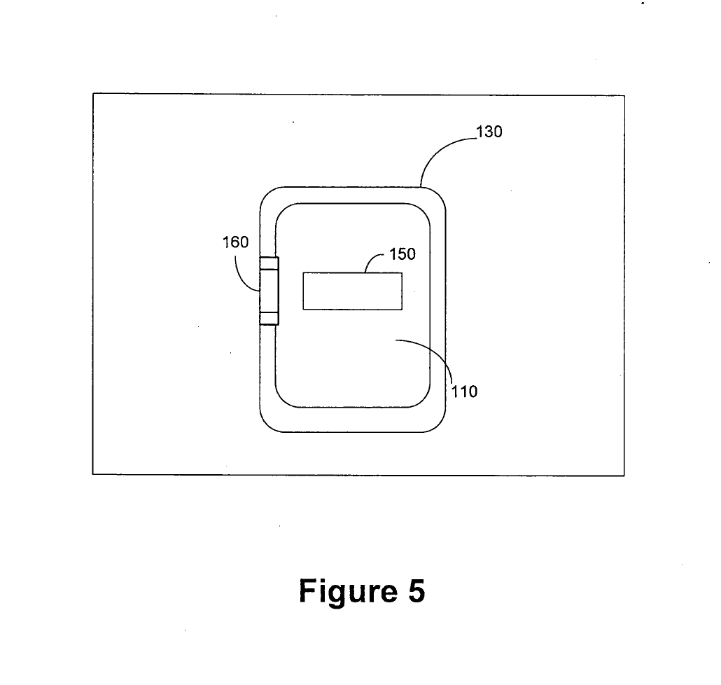

In an exemplary embodiment depicted in FIGS. 1-5, an opening mechanism 150 is secured to the interior side of door 110 that engages a latch mechanism 160 that is defined within peripheral frame 130. In this exemplary embodiment, latch mechanism 160 is located on the interior of door 110 and when the door 110 is closed, latch mechanism 160 locks onto peripheral frame 130 and locks door 110 shut. Moving opening mechanism 150 out of latch mechanism 160 releases latch mechanism 160 from peripheral frame 130 unlocking door 110 and enabling it to be opened.

In another exemplary embodiment, latch mechanism 160 is defined by peripheral frame 130. Opening mechanism 150 slidingly engages latch mechanism 160 to lock door 110 in a closed state. Moving opening mechanism 150 to slide out of latch mechanism 160 unlocks door 110 and it can be pushed open by a person trapped inside trailer 105.

Opening mechanism 150 is any structure accessible from the interior of the enclosure that allows door 110 to be in a locked closed position or an unlocked state whereby door 110 can be moved to an open position. For example, opening mechanism 150 may be a latch, push bar, lever, knob and/or the like. As shown in an exemplary embodiment in FIG. 1, opening mechanism 150 is a horizontal push bar. When the push bar is activated, door 110 pivots on hinges and opens outwardly. In another exemplary embodiment, opening mechanism 150 is a lever that may only be activated by upward rotation in order to prevent downward falling cargo from activating the lever. Opening mechanism 150 may be secured to door 110 via any known attachment method, such as screws, bolts, and the like.

Furthermore, opening mechanism 150 may be recessed in an access hole that is located inside door 110 such that opening mechanism 150 is flush with the interior surface of door 110. In one exemplary embodiment, opening mechanism 150 is hidden by the door panel and the access hole is below opening mechanism 150 such that falling cargo cannot enter the access hole and activate opening mechanism 150. Furthermore, the access hole and/or opening mechanism 150 may be surrounded by luminescent paint so that they may be located in the dark. Alternatively, a sign may be placed near door 110 or opening mechanism 150 which indicates that escape hatch 100 may be used as an exit.

In certain exemplary embodiments, opening mechanism 150 may be connected to a spring or other device that applies pressure to opening mechanism 150 to keep it engaged to latch mechanism 160. In these embodiments, escape hatch 100 can be opened if the person trapped inside the enclosure applied enough force to opening mechanism 150 to disengage it from latch mechanism 160. Applying pressure to keep opening mechanism 150 engaged to latch mechanism 160 ensures that door 110 does not open inadvertently.

In other exemplary embodiments, opening mechanism 150 can be pneumatically engaged to latch mechanism 160 and can comprise one or more pneumatic pins. For example, in an exemplary embodiment, a pneumatic pressure device, optionally having an accumulator, a pneumatic pressure brake system, an integral hand pump, or an independent source of pneumatic pressure may be used to insert and remove opening mechanism 150 from latch mechanism 160 or to otherwise operate opening mechanism 150. In other exemplary embodiments, pneumatic valves, rams and actuators, and/or a backup hand pump may be used to operate opening mechanism 150.

In another exemplary embodiment, hydraulic pressure may be used to insert and remove opening mechanism 150 into/from latch mechanism 160. Hydraulic pressure may be from a truck or container system, from an independent source, or from an integral hand pump. In other embodiments hydraulic valves, rams, actuators and a backup hand pump may be used.

In yet other exemplary embodiments, an electrical circuit with servo-relays and/or motors, vehicle or container electrical power, or an independent source of power may be used to insert and remove opening mechanism 150 into/from latch mechanism 160. Some exemplary embodiments may further comprise an internal emergency reserve battery and a reserve battery charger. An electrically driven opening mechanism 150 can be operated from a key pad or other control interface that is hard-wired to opening mechanism 150 or it can be operated wirelessly by remote control through known wireless communications standards, mediums, and protocols. Certain exemplary standards include the WiFi and Bluetooth protocol.

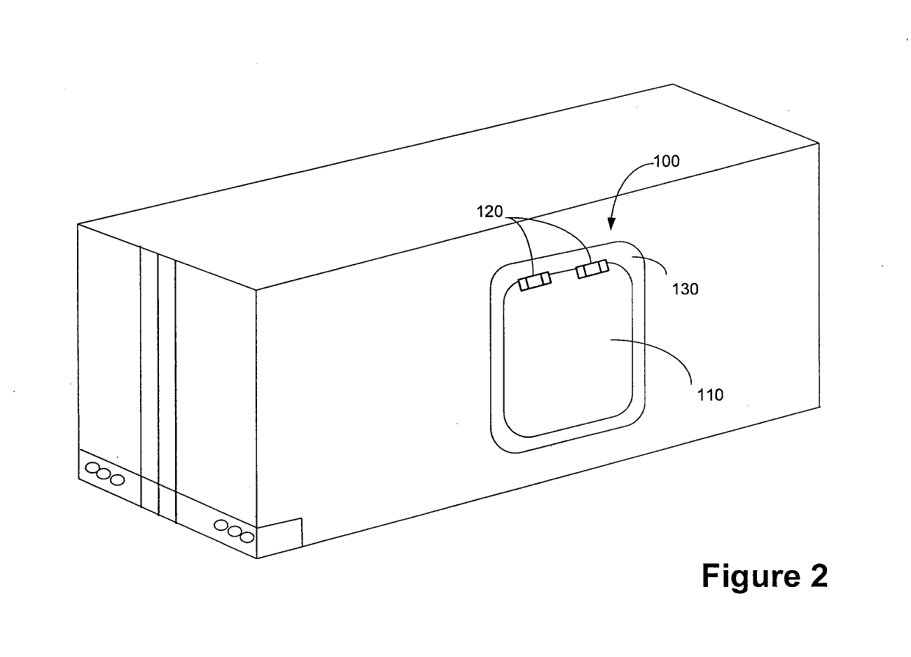

As shown in the Figures, escape hatch 100 further comprises an opening 140 having a peripheral frame 130. Opening 140 is any cavity, orifice or outlet created within the enclosure that permits egress from the enclosure. Opening 140 may be of any size and shape suitable to permit human passage, depending on the desired application. For example, opening 140 as depicted in FIG. 1 has approximate dimensions of about 2 feet by about 2 feet and is rectangular with curved corners. In other exemplary embodiments, opening 140 may be much smaller and may be of any other geometrical shape, such as a square, a circle and the like. As shown in FIGS. 1-4, door 110 can be located on any side of trailer 110 including the rear section as shown in FIG. 1 and the side sections as depicted in FIGS. 2-4. Door 110 may be constructed so as to be substantially flush with the external side of the trailer 105 when closed.

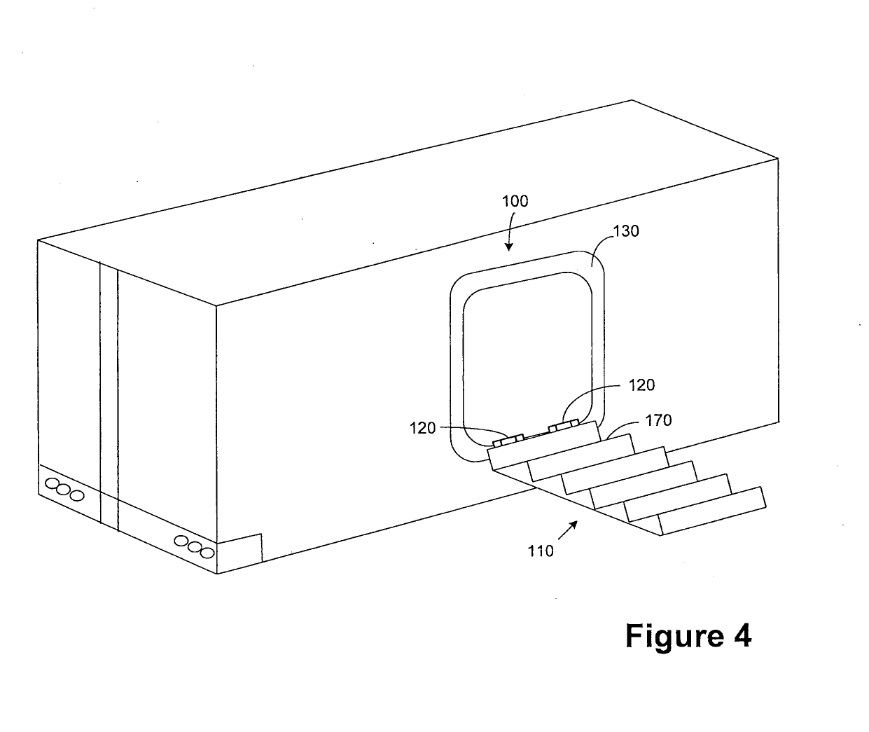

Door 110 is any device capable of covering the opening 140 and preventing exterior access to trailer 105 while allowing interior egress from trailer 105. In one exemplary embodiment, door 110 may hinge-mounted on the side of the peripheral frame to permit the door 110 to pivot as a standard door. In another exemplary embodiment, door 110 may be a removable panel that fits within opening 140. Further, door 110 may be attached at any location on the peripheral frame 130. For example, FIG. 4 shows the door 110 as hinge-mounted to the top of the peripheral frame 130, thus permitting door 110 to swing upwardly open. Alternatively, door 110 may be secured to peripheral frame 130 in such a way as to allow the door 110 to slide open. For example, peripheral frame 130 may have grooves and/or rollers that match up with corresponding grooves on door 110 such that door 110 may slide and/or roll horizontally or vertically to an open position.

In an exemplary embodiment, door 110 is solid so as to completely block the passage of matter. Moreover, in another exemplary embodiment, door 110 is a “grating” or otherwise vented so as to permit the passage of some matter, such as air and light, to the interior of the trailer 105 while simultaneously preventing entry top the enclosure from the exterior side of the enclosure. Furthermore, door 110 may be hollow, and the hollow space may be filled with a material, for example plywood or any other suitable filler material, to strengthen the structure of door 110 and reduce denting of door 110.

In an exemplary embodiment, door 110 is made of aluminum or steel. However, it will also be appreciated by one skilled in the art that door 110 may be manufactured of any known material, such as plywood, glass, and the like and may be painted any desired color. In one exemplary embodiment, door 110 may be painted so as to match the exterior of trailer 105, thereby reducing external visibility.

As mentioned above, escape hatch 100 may comprise a peripheral frame 130. Peripheral frame 130 may be any structure that extends around the outer surface of opening 140 and permits attachment of door 110. In one exemplary embodiment, peripheral frame 130 may be made formed as a unit with the existing trailer structural components, such as vertical posts, in order to meet trailer wall strength requirements. Furthermore, horizontal reinforcements above and below escape hatch 100 may extend to the vertical support posts and may be formed as a unit with peripheral frame 130. Furthermore, peripheral frame 130 may be flanged to prevent inward and/or outward motion between peripheral frame 130 and the adjacent wall paneling of trailer 105.

In one exemplary embodiment, peripheral frame 130 has grooves to facilitate attachment of weather stripping to create a hermetic seal. Weather stripping materials used to create hermetic seals, such as rubber, are known in the art. However, it will be appreciated that any material that prevents the passage of matter may be used to create a seal.

Door 110 is attached to peripheral frame 130 via an attachment mechanism 120. Attachment mechanism 120 is any device, such as hinges, grooves and the like, that secures door 110 to peripheral frame 130 and permits opening of door 110. In an exemplary embodiment, door 110 is pivotally attached to the peripheral frame 130 via spaced-apart hinges. In this embodiment, the hinges are installed so that door 110 opens outwardly.

In an exemplary embodiment, escape hatch 100 further comprises a latch mechanism 160. A latch mechanism 160 is any mechanism that is secured to door 110 or peripheral frame 130 to hold door 110 shut. Latch mechanism 160 generally works in conjunction with the door opening mechanism 150 to allow the door to open and close. In one exemplary embodiment, latch mechanism 160 is secured to peripheral frame 130 or defined by peripheral frame 130 and is meant to receive opening mechanism 150. In this regard, latch mechanism 160 is a recess or latch meant to receive one or more pins or other members of opening mechanism 150.

In another exemplary embodiment, latch mechanism 160 is attached to door 110 and may comprise a bolt that projects to peripheral frame 130 and seats in a recess located on peripheral frame 130 when the door 110 is closed. When opening mechanism 150 is activated, the bolt retracts into the door, thus allowing door 110 to open. Furthermore, latch mechanism 160 may comprise any number of bolts, operated individually or by activating opening mechanism 150, in order to increase the strength of escape hatch 100 and to protect escape hatch 100 from cargo damage. Furthermore, the bolt may be configured to have a positive locking mechanism so that it cannot be pried open from the outside. However, any latch mechanism 160 that is known, or as yet unknown in the art may be used.

In another exemplary embodiment, a locking mechanism, not depicted in the Figures, is mounted to the interior of door 110 as an additional security precaution. Locking mechanisms are known in the art and include any mechanism that is capable of locking escape hatch 100 from the inside, such as a deadbolt lock and/or the like.

In various exemplary embodiments, escape hatch 100 further comprises stairs to facilitate egress from the trailer 105. For example, FIG. 4 shows door 110 as hingedly secured to the bottom of peripheral frame 130. In this exemplary embodiment, a set of stairs 170 are secured to the interior side of door 110 such that when door 110 is opened the stairs 170 permit egress from the trailer. In another exemplary embodiment, stairs 170 may comprise foot holes located in the interior side of door 110 so that the interior side of door 110 is flush with the interior side of trailer 105.

In various exemplary embodiments, escape hatch 100 further comprises an alarm that will trigger when door 110 breaks contact with peripheral frame 130. An alarm is any device which alerts people when the door 110 is ajar. In some embodiments, the alarm may be auditory, such as a bell, or may be visual, such as an illuminated light bulb. In some embodiments, the alarm may be deactivated, bypassed, or placed on silent mode in situations where it is desirable to leave escape hatch 100 open, such as to let in additional light and air. Alarms are known in the art and are commercially available through suppliers.

In other exemplary embodiments, escape hatch 100 of the present invention may further comprise a disabling mechanism which prevents the activation of opening mechanism 150 if the enclosure is trailer 105 and trailer 105 is in motion. The motion/speed input may be from a speedometer of trailer 105, from an independent motion/speed sensor, or by sensing when trailer's 105 brakes are disengaged.

In certain exemplary embodiments, the trailer escape hatch of the present invention may be manufactured as a unit and installed when trailer 105 is manufactured. However, one skilled in the art will appreciate that escape hatch 100 may be retrofitted on existing trailers 105 or any other enclosure. For example, in the embodiments described above, a location for escape hatch 100 is selected and an opening 140 large enough to permit egress exit is cut out of the trailer 105 using known cutting methods. The material cut from the trailer itself is then converted to door 110 by adding a latching mechanism 160 and an opening mechanism 150. Of course, new material may likewise be used for fabrication of the door. A peripheral frame 130 is then installed around the opening 140, and a door 110 is secured to the peripheral frame 130 via an attachment mechanism.

Methods of cutting opening 140 in trailer 105 will vary depending on the material composition of the trailer 105. For example, if trailer 105 is made of steel, various torches are known in the art and may be used to create opening 140. However, it will be appreciated that opening 140 may be cut in the trailer 105 using any known or as yet unknown methods of cutting that are suitable for the material of the trailer.

Opening 140 may be cut at various locations on the trailer depending on the desired location of escape hatch 100. For example, in FIG. 1, opening 140 is located on the rear of trailer 105. However, it will be appreciated by one skilled in the art that opening 140 may be located anywhere on the trailer 105, such as the sides of the trailer, the roof, and the like and still fall within the present invention. For example, in various embodiments, opening 140 is cut in an existing trailer roll-up door so as to create escape hatch 100 within a door 110.

Although the invention has been described herein in conjunction with the appended drawings, those skilled in the art will appreciate that the scope of the invention is not so limited. Modifications in the selection, design, and arrangement of the various components and steps discussed herein may be made without departing from the scope of the invention.

1. A trailer comprising:
a body comprising front and rear sections connected by side sections;
an ingress/egress door located on the rear section; and
an escape hatch located on the body comprising a door and an opening mechanism controlling the operation of the door.

2. The trailer according to claim 1, wherein the escape hatch further comprises a peripheral frame around an opening that the door is seated within when the door is in a closed position.

3. The trailer according to claim 2, wherein the escape hatch further comprises a latch mechanism engaged to the opening mechanism.

4. The trailer according to claim 3, wherein the latch mechanism is located on the door.

5. The trailer according to claim 4, wherein the latch mechanism comprises a bolt projecting into a recess defined by the peripheral frame.

6. An enclosure comprising:
a transportable body with an interior and exterior side;
an ingress/egress door attached to the body;
an escape hatch comprising;
an opening defined by the transportable body,
a peripheral frame disposed within the opening,
a door connected to the peripheral frame by an attachment mechanism,
an opening mechanism attached to the door,
a latch mechanism engaged to the opening mechanism,
wherein the escape hatch is large enough to allow a human being to pass through between the interior and exterior sides but smaller than the ingress/egress door.

7. The enclosure according to claim 6, wherein the enclosure is a semi-trailer.

8. The enclosure according to claim 7, further comprising a disabling mechanism coupled to the opening mechanism to prevent the opening mechanism from operating when the semi-trailer is in motion.

9. The enclosure according to claim 6, wherein the escape hatch has dimensions of about two feet by two feet.

10. The enclosure according to claim 6, wherein the door is solid.

11. The enclosure according to claim 6, wherein the door is vented to enable fresh air and light to enter the enclosure.

12. The enclosure according to claim 6, wherein the enclosure has front and rear sections connected by side sections and the escape hatch is located on a side section.

13. The enclosure according to claim 6, wherein the escape hatch is located within the ingress/egress door.

14. The enclosure according to claim 6, further comprising a set of stairs attached to the door.

15. The enclosure according to claim 6, wherein the ingress/egress door is collapsible.

16. A tractor trailer comprising:
a rectangular body defining front and rear sections connected by side sections;
a set of two ingress/egress doors located on the rear section;
an escape hatch comprising;
an opening defined by the rectangular body,
a peripheral frame disposed within the opening,
a door connected to the peripheral frame by an attachment mechanism,
an opening mechanism attached to the door,
a latch mechanism attached to the door and engaged to the opening mechanism,
wherein the escape hatch is large enough to allow a human being to pass through the escape hatch but smaller than either of the ingress/egress doors.

17. The tractor trailer according to claim 16, wherein door further comprises a set of stairs.

18. The tractor trailer according to claim 16, wherein the opening mechanism is a horizontal push bar.

19. The tractor trailer according to claim 16, wherein the escape hatch has dimensions of about two feet by two feet.

20. The tractor trailer according to claim 16, wherein the opening mechanism is disposed within an access hole defined by the door.
